(19) United States
(12) Patent Application Publication
(10) Pub. No.: US 2021/0163349 A1
(43) Pub. Date: Jun. 3, 2021

(54) METHODS TO MITIGATE HAZE INDUCED DURING ION EXCHANGE WITH CARBONATE SALTS

(71) Applicant: CORNING INCORPORATED, Corning, NY (US)

(72) Inventors: Yuhui Jin, Painted Post, NY (US); Qiao Li, Horseheads, NY (US); Wei Sun, Painted Post, NY (US)

(21) Appl. No.: 17/108,595

(22) Filed: Dec. 1, 2020

Related U.S. Application Data
(60) Provisional application No. 62/942,425, filed on Dec. 2, 2019.

(51) Int. Cl. C03C 21/00

(52) U.S. Cl. CPC C03C 21/002

(57) ABSTRACT

A chemical ion exchange process, including: dissolving a carbonate salt in a molten salt bath disposed in a furnace and including a non-lithium non-carbonate alkali salt; immersing a lithium-containing glass-based substrate in the molten salt bath including the dissolved carbonate salt and the non-lithium non-carbonate alkali salt, where immersing the lithium-containing glass-based substrate in the molten salt bath results in an ion-exchange between the lithium-containing glass-based substrate and the molten salt bath and results in the formation of a lithium-containing carbonate salt in the molten salt bath; and reducing a concentration of the lithium-containing carbonate salt in the molten salt bath or increasing a solubility limit of the lithium-containing carbonate salt in the molten salt bath.

This application claims the benefit of priority under 35 U.S.C. § 119 of U.S. Provisional Application Ser. No. 62/942,425 filed on Dec. 2, 2019, the content of which is relied upon and incorporated herein by reference in its entirety.

### FIELD

The present disclosure relates to mitigation of the effects of lithium in molten salt baths. In particular, the present disclosure relates to mitigation of transmittance haze formed on glass-based articles due to the presence of lithium in molten salt baths during ion exchange of lithium containing glass-based substrates.

### BACKGROUND

The mobile nature of portable devices, such as smart phones, tablets, portable media players, personal computers, and cameras, makes these devices particularly vulnerable to accidental dropping on hard surfaces, such as the ground. Cover glasses adhered to these devices often function as display covers, which may incorporate touch functionality. In the event that a device is dropped, the cover glass may become damaged upon impact with a hard surface, thereby potentially reducing functionality of the device.

Glass can be made more resistant to fracture through an ion exchange process, which involves inducing compressive stress in the glass surface in a molten salt bath. In particular, lithium containing glass substrates have been subjected to ion exchange treatments for cover glass production because inclusion of lithium in these glasses allows for production of ion exchanged glass articles with a greater depth of compression at a faster exchange rate than glass substrates having other compositions. Glass substrates strengthened using this process typically exhibit improved performance, such as fracture resistance when dropped, when included in consumer electronic devices.

The ion exchange of lithium containing glasses in molten salt baths results in the release of lithium ions from the glass into the bath. This phenomenon is commonly referred to as ion exchange bath poisoning. The lithium poisoning of the ion exchange bath reduces the effectiveness of the ion exchange process, and eventually prevents the ion exchanged articles from exhibiting the desired compressive stress characteristics.

In order to counteract lithium poisoning, carbonate salts may be dissolved into the molten salt baths. The carbonate anions bind lithium cations to form LiCO₃⁻, which is soluble in a salt bath, but has a much larger ion diameter than the lithium cations. Accordingly, the lithium cations are passivated, and cannot participate in ion exchange because the LiCO₃⁻ cannot diffuse back into the glass substrate. Thus, the ion exchange process can continue with very little impact from lithium poisoning.

However, the addition of carbonate salts to the molten salt bath during the ion exchange process typically results in transmittance haze formation on glass articles when the salt baths are used for multiple cycles, meaning multiple glass substrates are ion exchanged in the same molten salt bath. Glass articles with transmittance haze have a layer of sub-micron or micron features engraved into the glass, reducing their optical transparencies.

Generally, transmittance haze is caused when an excess of lithium cations are released from lithium containing glass substrates into a molten salt bath such that the solubility limit of Li₂CO₃ is reached, resulting in formation of small Li₂CO₃ crystals within the bath. These crystals can be deposited on the surfaces of glass substrates being ion exchanged within the molten salt bath. If moisture is present in the atmosphere above the salt bath, the Li₂CO₃ may react with water to produce OH⁻ ions. The presence of such OH⁻ ions may elevate the pH of the salt bath at the interface of the Li₂CO₃ crystals and the glass substrate, which may induce localized etching of the glass. The etching process can leave permanent structures on the glass surface, and the increase in pH may lead to the corrosion of the glass, making the surface rough, i.e., produce transmittance haze.

There is a need to mitigate the formation of transmittance haze such that the same molten salt bath may be reused several times to ion exchange multiple glass substrates. By reusing the same molten salt bath, production costs are reduced and the yield of glass articles may be improved.

### BRIEF SUMMARY

The present disclosure is directed to methods for mitigation of transmittance haze formed on glass articles due to the presence of lithium in molten salt baths during ion exchange of lithium containing glass substrates. The ion exchange process may induce compressive stresses on the surfaces of the glass-based substrates in order to enhance their resistance to fracture when impacted. In some embodiments, the glass-based articles may, for example, be used as cover glass for electronic devices. In some embodiments, the glass-based substrates may be lithium containing glass-based substrates. When lithium containing glass-based substrates are ion exchanged in a molten salt bath within a furnace, for example, a concentration of lithium in the bath may become too high, which may poison the bath and prevent any further ion exchange. In some embodiments, carbonate ions may be dissolved in the molten salt bath to bind with lithium ions in order to counteract the poisoning. In some embodiments, the carbonate ions may react with the lithium to form lithium carbonate, which may crystallize within the molten salt bath. Crystallization of lithium carbonate may, for example, cause etching of glass-based substrates that may be ion exchanged within the molten salt bath, leading to formation of transmittance haze on the surfaces of glass-based articles that may be produced through ion exchange according to some embodiments. In some embodiments, silicic acid may be added to the molten salt bath to mitigate the effects of the lithium carbonate. In some embodiments, anhydrous phosphate salts may be added to the molten salt bath to mitigate the effects of the lithium carbonate. In some embodiments, a CO₂ atmosphere may be introduced into the furnace to reduce the amount of moisture in the furnace and to reduce the pH of the molten salt bath.

A first aspect (1) of the present application is directed to a chemical ion exchange process, the process including dissolving a carbonate salt in a molten salt bath disposed in a furnace and including a non-lithium non-carbonate alkali salt; immersing a lithium-containing glass-based substrate in the molten salt bath including the dissolved carbonate salt and the non-lithium non-carbonate alkali salt, where immersing the lithium-containing glass-based substrate in the molten salt bath results in an ion-exchange between the lithium-containing glass-based substrate and the molten salt bath and results in the formation of a lithium-containing carbonate salt in the molten salt bath; and reducing a concentration of the lithium-containing carbonate salt in the molten salt bath or increasing a solubility limit of the lithium-containing carbonate salt in the molten salt bath.

In a second aspect (2), the process according to the first aspect (1) is provided, and reducing the concentration of the lithium-containing carbonate salt in the molten salt bath or increasing a solubility limit of the lithium-containing carbonate salt in the molten salt bath according to embodiments of the preceding paragraph includes one or more of: (i) directing a gas including CO₂ into the furnace such that the molten salt bath is in contact with the gas; (ii) dissolving silicic acid in the molten salt bath; or (iii) dissolving at least one of anhydrous sodium or a potassium phosphate salt in the molten salt bath.

In a third aspect (3), the process according to the second aspect (2) is provided and reducing the concentration of the lithium-containing carbonate salt in the molten salt bath includes at least one of (ii) or (iii).

In a fourth aspect (4), the process according to the second aspect (2) is provided and reducing the concentration of the lithium-containing carbonate salt in the molten salt bath includes (i).

In a fifth aspect (5), the process according to the second aspect (2) or the third aspect (3) is provided and a concentration of the silicic acid within the molten salt bath is within a range of 0.1 wt % to 2 wt % after the silicic acid has been dissolved in the molten salt bath.

In a sixth aspect (6), the process according to any of aspects (2), (3), or (5) is provided and the concentration of the lithium-containing carbonate salt in the molten salt bath is reduced by up to 0.5 wt %.

In a seventh aspect (7), the process according to any of aspects (2), (3), (5), or (6) is provided and the concentration of the lithium-containing carbonate salt in the molten salt bath is reduced by at least 0.1 wt %.

In an eighth aspect (8), the process according to any of aspects (1)-(7) is provided and removing the lithium-containing glass-based substrate from the molten salt bath after a period of time sufficient to induce a target compressive stress on a surface of the lithium-containing glass-based substrate, wherein the lithium-containing glass-based substrate has a transmittance haze of less than 0.03% after being removed from the molten salt bath.

In a ninth aspect (9), the process according to any of aspects (1)-(8) is provided and the lithium-containing carbonate salt is Li₂CO₃.

In a tenth aspect (10), the process according to any of aspects (1)-(9) is provided and the concentration of the lithium-containing carbonate salt within the molten salt bath is within a range of 0.1 wt % to 0.3 wt % before reducing the concentration of the lithium-containing carbonate salt or increasing a solubility limit of the lithium-containing carbonate salt.

In an eleventh aspect (11), the process according to any of aspects (1)-(10) is provided and reducing the concentration of the lithium-containing carbonate salt in the molten salt bath or increasing a solubility limit of the lithium-containing carbonate salt in the molten salt bath is performed prior to immersing the lithium-containing glass-based substrate in the molten salt bath.

In a twelfth aspect (12), the process according to any of aspects (1)-(10) is provided and reducing the concentration of the lithium-containing carbonate salt in the molten salt bath or increasing a solubility limit of the lithium-containing carbonate salt in the molten salt bath is performed while the lithium-containing glass-based substrate is immersed in the molten salt bath.

In a thirteenth aspect (13), the process according to any of aspects (1)-(12) is provided and includes removing the lithium-containing glass-based substrate from the molten salt bath after a period of time sufficient to induce a target compressive stress on a surface of the lithium-containing glass-based substrate; immersing a second lithium-containing glass-based substrate in the molten salt bath; and removing the second lithium-containing glass-based substrate from the molten salt bath after a period of time sufficient to induce a target compressive stress on a surface of the second lithium-containing glass-based substrate.

In a fourteenth aspect (14), the process according to the thirteenth aspect (13) is provided and the second lithium-containing glass-based substrate has a transmittance haze of less than 0.03% after being removed from the molten salt bath.

In a fifteenth aspect (15), the process according to the second aspect (2) is provided and the gas including CO₂ is configured to reduce an atmospheric moisture content of an interior space within the furnace to no more than 1%.

In a sixteenth aspect (16), the process according to the second aspect (2) or the fifteenth aspect (15) is provided and the gas including CO₂ is configured to reduce the pH of the molten salt bath.

In a seventeenth aspect (17), the process according to any of aspects (2), (15), or (16) is provided and directing the gas including CO₂ into the furnace includes flowing the gas into an interior space within the furnace.

In an eighteenth aspect (18), the process according to the seventeenth aspect (17) is provided and the gas including CO₂ completely fills the interior space within the furnace.

In a nineteenth aspect (19), the process according to the seventeenth aspect (17) is provided and directing the gas including CO₂ into the furnace includes bubbling the gas inside the salt bath.

In a twentieth aspect (20), the process according to the nineteenth aspect (19) is provided and the gas is bubbled inside the salt bath for one hour or more.

In a twenty-first aspect (21), the process according to any of aspects (1)-(20) is provided and includes monitoring a concentration of a non-carbonate lithium-containing salt in the molten salt bath.

In a twenty-second aspect (22), the process according to the twenty-first aspect (21) is provided and reducing a concentration of the lithium-containing carbonate salt in the molten salt bath or increasing the solubility limit of the lithium-containing carbonate salt in the molten salt bath is performed when a concentration of the non-carbonate lithium-containing salt within the molten salt bath reaches at least 0.3 wt %.

In a twenty-third aspect (23), the process according to any of aspects (1)-(22) is provided and the non-lithium non-carbonate alkali salt is NaNO₃ or KNO₃.

In a twenty-fourth aspect (24), the process according to any of aspects (1)-(23) is provided and the molten salt bath including the non-lithium non-carbonate alkali salt includes NaNO₃ within a range of 5 wt % to 50 wt %, and KNO₃ within a range of 50 wt % to 95 wt %.

In a twenty-fifth aspect (25) the process according to any of aspects (1)-(24) is provided and the carbonate salt is K2CO₃ or Na2CO_{3.}

In a twenty-sixth aspect (26), the process according to any of aspects (1)-(25) is provided and the molten salt bath including the non-lithium non-carbonate alkali salt includes carbonate salt within a range of 0.5% to 10 wt % of a total weight of the molten salt bath.

A twenty-seventh aspect (27) of the present application is directed to a chemical ion exchange process, the process including: dissolving a carbonate salt in a molten salt bath including a non-lithium non-carbonate alkali salt, the molten salt bath disposed in a furnace including a CO₂ atmosphere above the molten salt bath; immersing a lithium-containing glass-based substrate in the molten salt bath including the dissolved carbonate salt and the non-lithium non-carbonate alkali salt, wherein immersing the lithium-containing glass-based substrate in the molten salt bath results in an ion-exchange between the lithium-containing glass-based substrate and the molten salt bath; and removing the lithium-containing glass-based substrate from the molten salt bath after a period of time sufficient to induce a target compressive stress on a surface of the lithium-containing glass-based substrate, wherein the lithium-containing glass-based substrate has a transmittance haze of less than 0.03% after being removed from the molten salt bath.

In a twenty-eighth aspect (28), the process according to the twenty-seventh aspect (27) is provided and the CO₂ atmosphere reduces the moisture content within the furnace.

In a twenty-ninth aspect (29), the process according to the twenty-seventh aspect (27) or the twenty-eighth aspect (28) is provided and the CO₂ atmosphere changes the pH of the molten salt bath.

In a thirtieth aspect (30), the process according to any of aspects (27)-(29) is provided and the CO₂ atmosphere causes an increase in the solubility limit of a lithium-containing carbonate salt in the molten salt bath.

In a thirty-first aspect (31), the process according to any of aspects (27)-(30) is provided and a concentration of the lithium-containing carbonate salt in the molten salt bath is within a range of 0.1 wt % to 0.3 wt %.

In a thirty-second aspect (32), the process according to any of aspects (27)-(31) is provided and the CO₂ atmosphere is created by flowing a gas including CO₂ into an interior space within the furnace.

In a thirty-third aspect (33), the process according to the thirty-second aspect (32) is provided and the CO₂ atmosphere completely fills the interior space within the furnace.

In a thirty-fourth aspect (34), the process according to any of aspects (27)-(33) is provided and includes bubbling a gas including CO₂ inside the salt bath.

In a thirty-fifth aspect (35), the process according to any of aspects (27)-(34) is provided and the target compressive stress on the surface of the lithium-containing glass-based substrate is 200 MPa or more.

In a thirty-sixth aspect (36), the process according to any of aspects (27)-(35) is provided and includes immersing a second lithium-containing glass-based substrate in the molten salt bath including the dissolved carbonate salt and the non-lithium non-carbonate alkali salt after removing the lithium-containing glass-based substrate from the molten salt bath, wherein immersing the second lithium-containing glass-based substrate in the molten salt bath results in an ion-exchange between the second lithium-containing glass-based substrate and the molten salt bath, and removing the second lithium-containing glass-based substrate from the molten salt bath after a period of time sufficient to induce a target compressive stress on a surface of the second lithium-containing glass-based substrate, where the second lithium-containing glass-based substrate has a transmittance haze of less than 0.03% after being removed from the molten salt bath.

In a thirty-seventh aspect (37), the process according to the thirty-sixth aspect (36) is provided and the target compressive stress on the surface of the lithium-containing glass-based substrate is 200 MPa or more, and wherein the target compressive stress on the surface of the second lithium-containing glass-based substrate is 200 MPa or more.

In a thirty-eighth aspect (38), the process according to any of aspects (27)-(37) is provided and includes dissolving silicic acid in the molten salt bath.

In a thirty-ninth aspect (39), the process according to any of aspects (27)-(38) is provided and includes dissolving at least one of anhydrous sodium or a potassium phosphate salt in the molten salt bath.

A fortieth aspect (40) of the present application is directed to a chemical ion exchange process, the process including: dissolving a carbonate salt in a molten salt bath disposed in a furnace and including a non-lithium non-carbonate alkali salt; immersing a first lithium-containing glass-based substrate in the molten salt bath for a period of time sufficient to induce a target compressive stress on a surface of the first lithium-containing glass-based substrate; immersing a second lithium-containing glass-based substrate in the molten salt bath for a period of time sufficient to induce a target compressive stress on a surface of the second lithium-containing glass-based substrate; and directing a gas including CO₂ into the furnace such that the molten salt bath is in contact with the gas before immersing at least one of: the first lithium-containing glass-based substrate in the molten salt bath or the second lithium-containing glass-based substrate in the molten salt bath.

In a forty-first aspect (41), the process according to the fortieth aspect (40) is provided and the second lithium-continuing glass-based substrate is immersed in the molten salt bath after the first lithium-continuing glass-based substrate is removed from the molten salt bath.

In a forty-second aspect (42), the process according to either the fortieth (40) or the forty-first aspect (41) is provided and the first lithium-containing glass-based substrate has a transmittance haze of less than 0.03% after being removed from the molten salt bath, and where the second lithium-containing glass-based substrate has a transmittance haze of less than 0.03% after being removed from the molten salt bath.

In a forty-third aspect (43), a first lithium-containing glass-based article and a second lithium-containing glass-based article produced by the process according to aspect (40) is provided.

In a forty-fourth aspect (44), the first lithium-containing glass-based article and the second lithium-containing glass-based article according to the forty-third aspect (43) are provided and both the first lithium-containing glass-based article and the second lithium-containing glass-based article have a transmittance haze of less than 0.03%.

In a forty-fifth aspect (45), the first lithium-containing glass-based article and the second lithium-containing glass-based article according to the forty-third aspect (43) are provided and both the first lithium-containing glass-based article and the second lithium-containing glass-based article have a transmittance haze of less than 0.01%.

### BRIEF DESCRIPTION OF THE DRAWINGS

The accompanying figures, which are incorporated herein, form part of the specification and illustrate embodiments of the present disclosure. Together with the description, the figures further serve to explain the principles of and to enable a person skilled in the relevant art(s) to make and use the disclosed embodiments. These figures are intended to be illustrative, not limiting. Although the disclosure is generally described in the context of these embodiments, it should be understood that it is not intended to limit the scope of the disclosure to these particular embodiments. In the drawings, like reference numbers indicate identical or functionally similar elements.

FIG. 1 depicts a cross section of a glass article having compressive stress layers on its surfaces according to some embodiments.

FIG. 2 depicts a setup for a molten salt bath disposed within a furnace according to some embodiments.

FIG. 3A is depicts a path of etching of glass by lithium carbonate according to some embodiments. FIG. 3B depicts paths of etching glass shown in FIG. 3A, as well as paths of preventing or inhibiting glass etching

FIG. 4A shows images of two samples of glass substrates having transmittance haze according to some embodiments. FIG. 4B is an SEM image of sample 1 of FIG. 4A.

FIG. 5 is an image of four samples of a glass substrate according to some embodiments.

FIG. 6A is a plan view of an electronic device incorporating a glass article according to some embodiments. FIG. 6B is a perspective view of the electronic device of FIG. 6A.

### DETAILED DESCRIPTION

The following examples are illustrative, but not limiting, of the present disclosure. Other suitable modifications and adaptations of the variety of conditions and parameters normally encountered in the field, and which would be apparent to those skilled in the art, are within the spirit and scope of the disclosure.

Glass articles used in various applications, for example, cover glass for different types of electronic devices, needs to have increased strength in order to protect the devices from impact. One method of strengthening glass is through an ion exchange process, which involves inducing compressive stresses in the surface of a glass substrate. Sodium containing glass substrates may be subjected to ion exchange treatments; however, lithium containing glass substrates may alternatively be used in order to maximize strength because the inclusion of lithium in the glass may allow for a greater depth of compression at a faster ion exchange rate than with sodium containing glasses. The resulting strengthened glass articles may exhibit improved performance, such as resistance to fracture when dropped, when included in consumer electronic devices.

As used herein, the terms “glass-based article” and “glass-based substrates” are used in their broadest sense to include any object made wholly or partly of glass. Glass-based articles include laminates of glass and non-glass materials, laminates of glass and crystalline materials, and glass-ceramics (including an amorphous phase and a crystalline phase). While much of the description and many of the examples herein are directed to glass articles, the concepts and results are applicable to glass-based materials, including glass-ceramic materials.

The ion exchange process may be conducted in a molten salt bath. The molten salt bath may include a first salt having a metal ion, which has a larger ionic radii than the alkali metal of an alkali metal oxide included in a glass substrate, and an anion, and a second salt that is dissolved in the molten salt bath and includes the same metal ion as the first salt and an anion different from the anion of the first salt. For example, in some embodiments, the molten salt bath includes a nitrate salt, such as KNO₃, NaNO₃, and their mixture. The molten salt bath may optionally include K₂CO₃, Na₂CO₃, K₃PO₄, Na₃PO₄, K₂SO₄, Na₂SO₄, K₃BO₃, Na₃BO₃, KCl, NaCl, KF, and NaF dissolved therein. The additional salt may be added to the molten salt bath as a dissolved liquid solute in order to facilitate ion exchange and enhance efficiency of the ion exchange process.

When the additional salt is a carbonate salt, and when a lithium containing glass substrate is ion exchanged within the molten salt bath, the lithium may react with the carbonate and Li₂CO₃ crystals may be formed. These crystals may be deposited on the surfaces of glass substrates being ion exchanged within the molten salt bath. If moisture is present in the atmosphere above the salt bath, the Li₂CO₃ may react with water to produce OH⁻ ions. The presence of such OH⁻ ions may elevate the pH of the salt bath at the interface of the Li₂CO₃ crystals and the glass substrate, which may induce localized etching of the glass. The etching process can leave permanent structures on the glass surface, or may lead to the corrosion of the glass, making the surface rough. These surface defects may be categorized as “transmittance haze,” which is undesirable not only because it decreases optical transparency of the glass articles, but also because the presence of transmittance haze reduces the compressive stresses induced by the ion exchange process. In addition, Li₂CO₃ crystals may have a direct solid-solid reaction with glass, which can make the glass surface rough and appear hazy.

Different techniques may be utilized, alone or in combination with one another, to mitigate the production of transmittance haze on the surfaces of glass articles. For example, in some embodiments, silicic acid may be added to the molten salt bath. The silicic acid may dissociate to release H⁺ ions, which may react with the OH⁻ ions to neutralize the salt bath, thereby quenching the etching process. However, if too much silicic acid is added to the bath, sludge may be formed on the bottom of the tank.

Additionally, in some embodiments, anhydrous sodium or potassium phosphate salts are added into the salt bath. Such alkali phosphates can react with lithium to form lithium phosphate salts, for example Li₃PO₄, Li₂NaPO₄, and Li₂KPO₄. Lithium phosphate salts may have very low solubility in a molten salt bath. Therefore, the lithium phosphate salts may be easily precipitated, and the formation of Li₂CO₃ crystals may be avoided because not enough lithium cations are present within the salt bath to react with the carbonate to generate Li₂CO₃. Like with silicic acid, though, too much phosphate salt within the molten salt bath may result in the formation of sludge in the bottom of the tank.

Finally, in some embodiments, the ion exchange process is executed under CO₂ atmosphere. The CO₂ may react with the OH⁻ ions in the salt bath, thereby reducing the OH⁻ ions by up to 50 times, which may neutralize the pH of the salt bath and quench the glass etching process. Additionally, the CO₂ atmosphere may replace the original atmosphere within the furnace and around the salt bath, which may contain moisture. Accordingly, the moisture contained within the original atmosphere may be prevented from entering the salt bath, which may increase the solubility limit of the Li₂CO₃, thereby helping to prevent formation of Li₂CO₃ crystals. In some embodiments, the CO₂ atmosphere may reduce an atmospheric moisture content of the interior space of the furnace to less than 10%. In some embodiments, the CO₂ atmosphere may reduce an atmospheric moisture content of the interior space of the furnace to less than 5%. In some embodiments, the CO₂ atmosphere may reduce an atmospheric moisture content of the interior space of the furnace to less than 1%. Furthermore, a reversible reaction between Li₂CO₃ and silicate glass may be controlled such that transmittance haze is not formed on the surface of the glass.

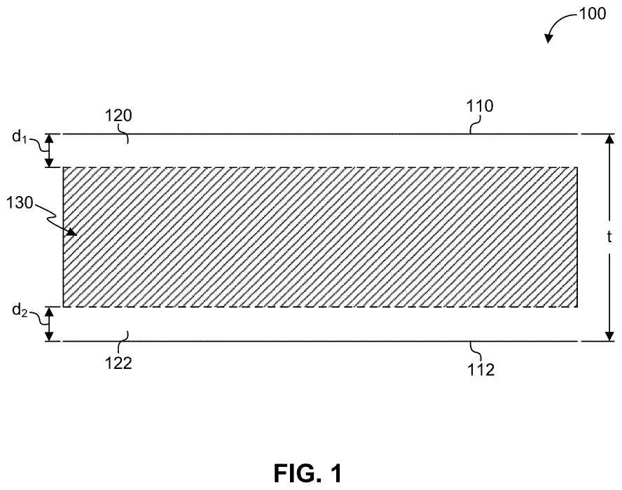

FIG. 1 depicts a glass article having compressive stress layers on its surfaces according to some embodiments. The compressive stress layers may be induced by an ion exchange process occurring within a molten salt bath. In some embodiments, a glass-based article 100 has a first region under compressive stress (e.g., first and second compressive layers 120, 122) extending from the surface to a depth of compression (DOC) of the glass-based article and a second region (e.g., central region 130) under a tensile stress or central tension (CT) extending from the DOC into the central or interior region of the glass-based article. As used herein, DOC refers to the depth at which the stress within the glass-based article changes from compressive to tensile. At the DOC, the stress crosses from a positive (compressive) stress to a negative (tensile) stress and thus exhibits a stress value of zero.

Compressive or compressive stress is typically expressed as a negative (<0) stress and tension or tensile stress is typically expressed as a positive (>0) stress. Throughout this description, however, CS is expressed as a positive or absolute value—i.e., as recited herein, CS=|CS|. The compressive stress (CS) has a maximum at the surface of the glass, and the CS varies with distance d from the surface according to a function. Referring again to FIG. 1, a first segment 120 extends from a first surface 110 to a depth d1 and a second segment 122 extends from a second surface 112 to a depth d2. Together, these segments define a compression or CS of glass-based article 100. Compressive stress (including surface CS) may be measured by surface stress meter (FSM) using commercially available instruments. Surface stress measurements may rely upon the accurate measurement of the stress optical coefficient (SOC), which is related to the birefringence of the glass. SOC in turn may be measured according to Procedure C (Glass Disc Method) described in ASTM standard C770-16, entitled “Standard Test Method for Measurement of Glass Stress-Optical Coefficient,” the contents of which are incorporated herein by reference in their entirety.

As discussed above, the compressive stress layers in glass articles may be formed by exposing glass substrates to an ion exchange bath. In some embodiments, the ion exchange bath may be a molten salt bath, such as a molten non-carbonate salt bath, for example a molten nitrate salt bath, a molten nitrite salt bath, a molten phosphate salt bath, or a molten sulfate salt bath. In some embodiments, the ion exchange bath may contain one of the above molten salt baths where potassium and/or sodium is the cation of the salt. In some embodiments, the ion exchange bath may be molten KNO₃, molten NaNO₃, or combinations thereof. The following ion exchange bath embodiments may refer to the composition of the bath prior to poisoning. In certain embodiments, the ion exchange bath may comprise less than about 95% molten KNO₃, such as less than about 90% molten KNO₃, less than about 80% molten KNO₃, less than about 70% molten KNO₃, less than about 60% molten KNO₃, or less than about 50% molten KNO₃. In certain embodiments, the ion exchange bath may comprise about 5% or more molten NaNO₃, such as about 10% or more molten NaNO₃, about 20% or more molten NaNO₃, about 30% or more molten NaNO₃, about 40% or more molten NaNO₃, or about 50% or more molten NaNO₃. In other embodiments, the ion exchange bath may comprise about 95% molten KNO₃ and about 5% molten NaNO₃, about 94% molten KNO₃ and about 6% molten NaNO₃, about 93% molten KNO₃ and about 7% molten NaNO₃, about 80% molten KNO₃ and about 20% molten NaNO₃, about 75% molten KNO₃ and about 25% molten NaNO₃, about 70% molten KNO₃ and about 30% molten NaNO₃, about 65% molten KNO₃ and about 35% molten NaNO₃, or about 60% molten KNO₃ and about 40% molten NaNO₃, and all ranges and sub-ranges between the foregoing values. In some embodiments, the ion exchange bath may include about 100% molten KNO₃ or about 100% molten NaNO₃. The above KNO₃ and NaNO₃ percentages are merely exemplary and similar percentages can be used when other sodium and potassium salts are used in the ion exchange solution, such as, for example sodium or potassium nitrites, phosphates, or sulfates. It should be understood that while molten nitrate salt baths are discussed herein for the sake of simplicity, the processes described herein may also utilize molten salt baths including any appropriate non-lithium non-carbonate alkali salt.

The glass substrates may be exposed to the ion exchange bath by immersing the glass substrates in the ion exchange bath. Upon exposure to the glass substrate, the ion exchange bath may, according to some embodiments, be at a temperature from greater than or equal to 350° C. to less than or equal to 420° C., such as from greater than or equal to 360° C. to less than or equal to 410° C., from greater than or equal to 370° C. to less than or equal to 400° C., or from greater than or equal to 380° C. to less than or equal to 390° C., and all ranges and sub-ranges between the foregoing values. In some embodiments, the glass substrates may be exposed to the ion exchange bath for a duration from greater than or equal to 10 minutes to less than or equal to 48 hours, such as from greater than or equal to 30 minutes to less than or equal to 44 hours, from greater than or equal to 1 hour to less than or equal to 40 hours, from greater than or equal to 4 hours to less than or equal to 36 hours, from greater than or equal to 8 hours to less than or equal to 32 hours, or from greater than or equal to 12 hours to less than or equal to 28 hours, and all ranges and sub-ranges between the foregoing values.

After the glass substrates are exposed to the ion exchange bath to form ion exchanged glass articles, the ion exchange bath may include lithium ions, which may result from the exchange of lithium ions out of the glass substrate during the ion exchange process. Once the concentration of lithium ions reaches a certain level, the ion exchange bath may be “poisoned” by the lithium. For example, an excess of lithium ions within the ion exchange bath may prevent further ion exchange of additional glass substrates. As utilized herein, a lithium poisoned molten salt bath refers to a molten salt bath that includes 0.1 wt % or more of a non-carbonate lithium containing salt, for example LiNO₃. In some embodiments, a lithium poisoned molten salt bath may include 0.3 wt % or more of a non-carbonate lithium containing salt.

In some embodiments, carbonate ions may be introduced to the ion exchange bath to counteract the effects of lithium poisoning. The carbonate ions may react with the lithium ions to form lithium carbonate or LiCO₃—, effectively deactivating the lithium ions, and the lithium carbonate may precipitate from the bath.

The carbonate ions may be introduced to the ion exchange bath by any process typically used to introduce ions into an ion exchange bath. In some embodiments, the carbonate ions may be introduced to the ion exchange bath by dissolving a carbonate salt in the ion exchange bath. For example, a carbonate salt may be added to an ion exchange bath that is at a bath temperature that will result in the carbonate salt at least partially dissolving in the bath. The carbonate salt added may be in solid form.

The lithium content of the molten salt bath may be given in terms of lithium nitrate for embodiments where the molten salt bath is a molten nitrate salt bath. In other embodiments, where the molten salt bath is a different molten salt bath (for example nitrite, phosphate, or sulfate salt baths), the lithium content is given in terms of the lithium version of the salt that makes up the molten salt bath. The molten salt bath also includes at least one other non-lithium non-carbonate alkali salt, such as a non-lithium alkali nitrate, for example those described above as useful for ion exchanging glass-based substrates. In some embodiments, the poisoned molten salt bath may include LiNO₃ in an amount greater than or equal to 0.1 wt % to less than or equal to 2.0 wt %, such as greater than or equal to 0.2 wt % to less than or equal to 1.8 wt %, greater than or equal to 0.3 wt % to less than or equal to 1.6 wt %, greater than or equal to 0.4 wt % to less than or equal to 1.4 wt %, greater than or equal to 0.5 wt % to less than or equal to 1.2 wt %, greater than or equal to 0.6 wt % to less than or equal to 1.0 wt %, greater than or equal to 0.7 wt % to less than or equal to 0.9 wt %, 0.8 wt %, and all ranges and sub-ranges between the foregoing values.

In some embodiments, the carbonate salt may be added in any appropriate amount and in any appropriate form. In some embodiments, the carbonate salt may be added to the bath in an amount of greater than or equal to 0.5 wt % to less than or equal to 10 wt % on the basis of the total bath weight, such as greater than or equal to 1 wt % to less than or equal to 9 wt %, greater than or equal to 2 wt % to less than or equal to 8 wt %, greater than or equal to 3 wt % to less than or equal to 7 wt %, greater than or equal to 4 wt % to less than or equal to 6 wt %, 5 wt %, and all sub-ranges and ranges between the foregoing values.

In some embodiments, the carbonate salt may be added in particulate form, without any particular limitation on the particle size of the carbonate salt. The performance of the carbonate salt in regenerating the bath is not directly dependent on the particle size, as the carbonate salt will be fully or at least partially dissolved in the bath. This allows the use of large particle sizes than other regeneration materials, such as phosphates, and the avoidance of the negative health effects and expense associated with very small particle sizes.

In some embodiments, the bath may subsequently be heated to facilitate the dissolution of the carbonate salt, as the solubility of the carbonate salt in the bath may increase as the temperature of the bath increases. In some embodiments, the molten salt bath may be heated to a temperature greater than or equal to 430° C. to less than or equal to 500° C., such as greater than or equal to 440° C. to less than or equal to 490° C., greater than or equal to 450° C. to less than or equal to 480° C., or greater than or equal to 460° C. to less than or equal to 470° C., and all ranges and sub-ranges between the foregoing values. In some embodiments, the molten salt bath may be heated before the addition of the carbonate salt.

The bath may then be cooled to form lithium carbonate precipitates in the bath. In some embodiments, the bath may be cooled to a temperature desired for the ion exchange process. The formation of the lithium carbonate precipitates may remove lithium ions from the bath, reducing the concentration of lithium ions in the bath. For example, the formation of lithium carbonate precipitates reduces the degree of lithium poisoning of the bath.

In some embodiments, the temperature at which the molten salt bath is maintained to carry out the ion exchange process is selected such that the added carbonate salt is soluble in the molten salt bath but lithium carbonate is not. Such a temperature allows for the added carbonate salt to be dissolved in the molten salt bath while lithium carbonate precipitates from the molten salt bath, removing lithium ions from the molten salt bath.

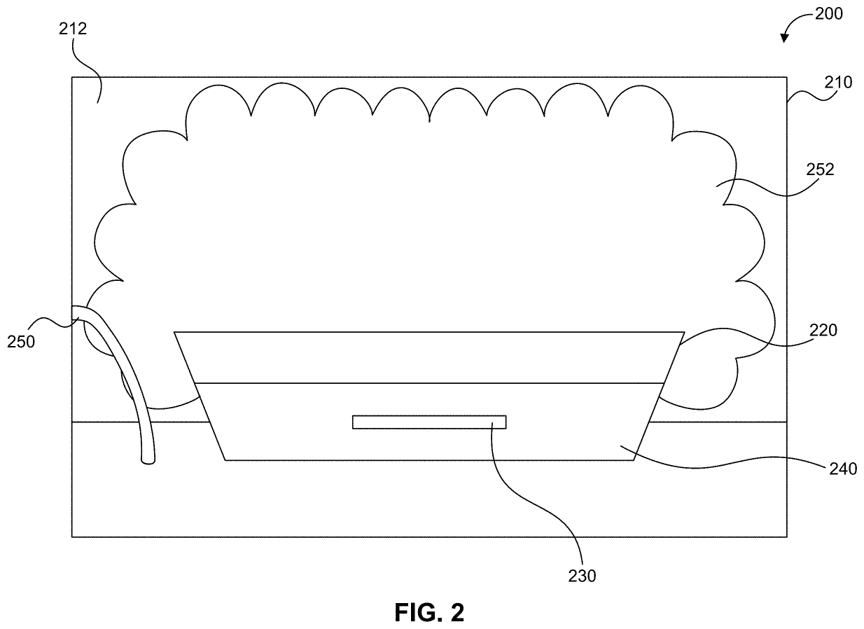

In some embodiments, as shown in FIG. 2, for example, the ion exchange process may be conducted using an ion exchange setup 200, and may include mixing a carbonate salt and at least one non-lithium non-carbonate alkali salt. In some embodiments, the at least one non-lithium non-carbonate alkali salt may be a non-lithium alkali nitrate salt, such as sodium nitrate or potassium nitrate. The mixture may then be melted in a tank 220 within a furnace 210 to form a molten salt bath 240 that contains carbonate ions and at least one non-lithium non-carbonate alkali salt. In some embodiments, the mixing may occur after the non-lithium non-carbonate alkali salt is melted. The non-lithium alkali salts in molten salt bath 240 may be any of those described above. Similarly, the carbonate salt may be any of those described above.

A lithium containing glass substrate 230 may be ion exchanged in molten salt bath 240 to form an ion exchange glass article. The temperature of bath 240 during the ion exchange may be any of the desired bath temperatures for ion exchange described above. Similarly, the ion exchange may extend for any of the time periods described above. The carbonate ions in molten salt 240 bath may interact with the lithium ions introduced to the molten salt bath from the glass-based substrate to form lithium carbonate precipitates, slowing the rate of the lithium poisoning of the bath. After the ion exchange, the molten salt bath may contain lithium ions. In some embodiments, the molten salt bath 240 after ion exchange contains less than 2.0 wt % LiNO₃, such as less than 1.9 wt % LiNO₃, less than 1.8 wt % LiNO₃, less than 1.7 wt % LiNO₃, less than 1.6 wt % LiNO₃, less than 1.5 wt % LiNO₃, less than 1.4 wt % LiNO₃, less than 1.3 wt % LiNO₃, less than 1.2 wt % LiNO₃, less than 1.1 wt % LiNO₃, less than 1.0 wt % LiNO₃, less than 0.9 wt % LiNO₃, less than 0.8 wt % LiNO₃, less than 0.7 wt % LiNO₃, less than 0.6 wt % LiNO₃, less than 0.5 wt % LiNO₃, less than 0.4 wt % LiNO₃, less than 0.3 wt % LiNO₃, less than 0.2 wt % LiNO₃, or less than 0.1 wt % LiNO₃, and all sub-ranges and ranges between the foregoing values.

Although the addition of carbonate ions to the molten salt bath may aid in preventing lithium poisoning, the Li₂CO₃ that is produced may negatively affect the glass articles produced through the ion exchange process. For example, Li₂CO₃ crystals within the bath may be deposited on the surfaces of glass substrates being ion exchanged within the molten salt bath. If moisture is present in the atmosphere above the salt bath, the Li₂CO₃ may react with water to produce OH— ions. The presence of such OH— ions may elevate the pH of the salt bath at the interface of the Li₂CO₃ crystals and the glass substrate, which may induce localized etching of the glass. The etching process can leave permanent structures on the glass surface, and the increase in pH may lead to the corrosion of the glass, making the surface rough. Both etching and corrosion result in formation of transmittance haze on the glass article. As used herein, “transmittance haze” means the amount of light that is subject to wide angle scattering at an angle greater than 2.5° from normal when passing through a material measured according to ASTM D1003 “Standard Test Method for Haze and Luminous Transmittance of Transparent Plastics.”

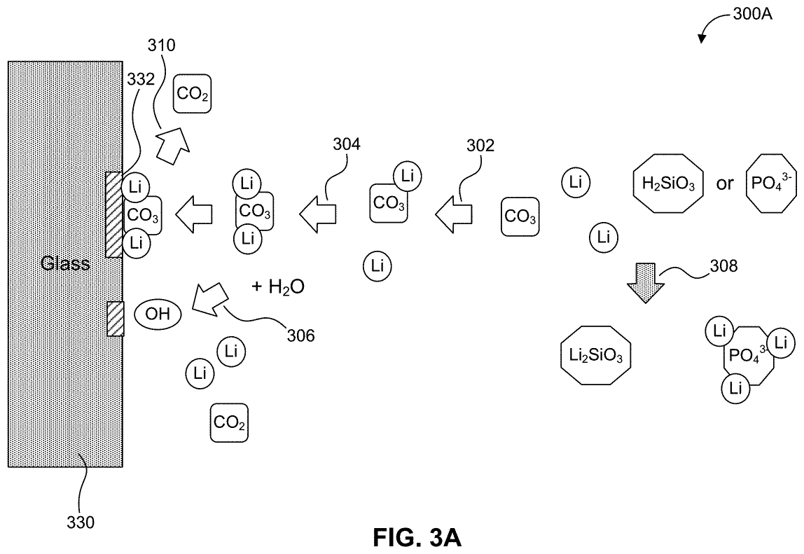

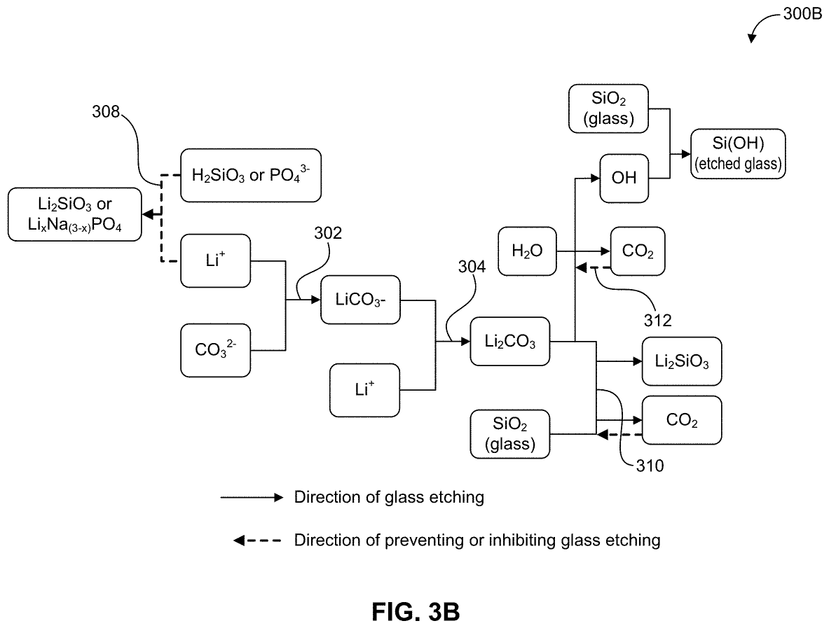

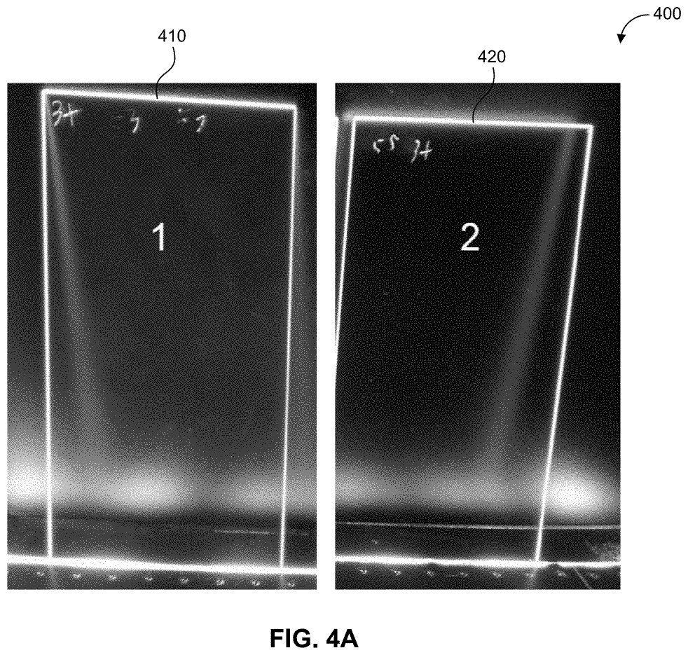

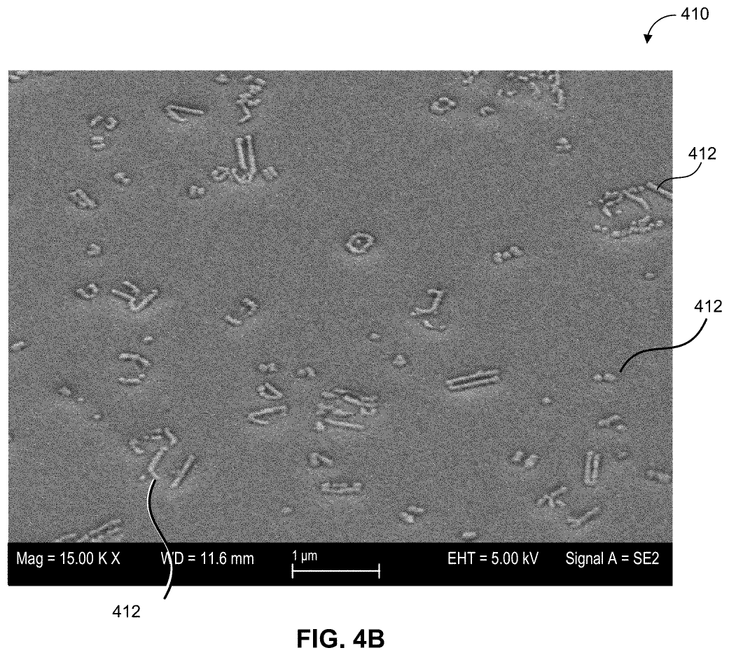

FIG. 3A depicts a path of etching glass, or inducing transmittance haze formation, by lithium carbonate 300A according to some embodiments. For example, reaction 302 (Li⁺+CO₃²⁻→LiCO₃⁻) produces LiCO₃⁻ in order to bind lithium cations and prevent lithium poisoning. However, reaction 304 (Li⁺+LiCO₃⁻→Li₂CO₃), which occurs as a greater concentration of LiCO₃ accumulates in the molten salt bath, produces Li₂CO₃ crystals, which may be deposited on the surface of glass substrate 330. In the presence of moisture, reaction 306 may occur (Li₂CO₃+H₂O→2OH⁻+2Li⁺+CO₂). The OH⁻ ions produced by reaction 306 may elevate the pH of the molten salt bath at the interface 332 of the Li₂CO₃ crystal, glass substrate, and molten salt bath, which may induce localized etching. Finally, a direct reaction may occur between Li₂CO₃ and the silicate glass (Li₂CO₃+SiO₂ (glass)↔Li₂SiO₃+CO₂). This direct reaction may lead to the corrosion of the glass substrate, making the surface rough and generating transmittance haze. As shown in FIGS. 4A and 4B, transmittance haze reduces the transparency of the glass articles. FIG. 4A depicts images 400 of a first lithium containing glass sample 410 and a second lithium containing glass sample 420, both having transmittance haze after being ion exchanged in a molten salt bath containing carbonate salts. Sample 410 was ion exchanged in a molten salt bath that had previously been used for ion exchange of glass substrates 53 times. Sample 420 was ion exchanged in a molten salt bath that had previously been used for ion exchange of glass substrates 26 times. FIG. 4B is an SEM image of a sample 410. The submicron features 412 shown in FIG. 4B are an example of transmittance haze. Features 412 cause a cloudy appearance in the glass article. In addition to reduced transparency, glass articles hazing transmittance haze may have reduced compressive stresses after the ion exchange process than glass articles without haze, and may have an undesirable bluish color.

Transmittance haze due to Li₂CO₃ is typically an issue in molten salt baths that have been used for ion exchange of glass substrates several times. For example, transmittance haze may occur when the Li₂CO₃ reaches its solubility limit, for example from 0.1 wt % to 0.2 wt %, or when the concentration of the Li₂CO₃ within a molten salt bath, composed of 86% KNO₃, 5% K₂CO₃ and 9% NaNO₃ at a temperature of 380° C., reaches approximately 0.3 wt %, although this concentration may vary depending on the salt composition, the temperature and moisture level within the tank.

In some embodiments, the concentration of Li₂CO₃ within the molten salt bath may reach 0.1 wt % to 1 wt % before reducing the concentration of the Li₂CO₃ and/or increasing the solubility limit of Li₂CO₃. For example, the concentration of Li₂CO₃ may be in a range of from greater than or equal to 0.1 wt % to less than or equal to 1 wt %, such as from greater than or equal to 0.2 wt % to less than or equal to 0.9 wt %, from greater than or equal to 0.3 wt % to less than or equal to 0.8 wt %, from greater than or equal to 0.4 wt % to less than or equal to 0.7 wt %, or from greater than or equal to 0.5 wt % to less than or equal to 0.6 wt %, and all ranges and sub-ranges between the foregoing values. In some embodiments, the concentration of Li₂CO₃ may be in a range of from greater than or equal to 0.1 wt % to less than or equal to 0.3 wt %.

However, the ability to reuse a molten salt bath to ion exchange as many glass substrates as possible is desirable in order to reduce cost and improve the yield of glass articles produces without transmittance haze.

There are a few different methods of preventing transmittance haze by either controlling the lithium concentration in the molten salt bath to avoid formation of Li₂CO₃ crystals, or by controlling the pH of the molten salt bath to ensure it remains low in order to avoid glass etching.

FIG. 3B depicts paths of etching glass (solid lines), for example those shown in FIG. 3A, as well as paths of preventing or inhibiting glass etching (broken lines). In some embodiments, silicic acid may be added into the molten salt bath in order to neutralize the pH of the bath. Silicic acid is a weak acid, and therefore dissociates easily. For example, the silicic acid may be partially dissolved into the molten salt bath, thereby dissociating and releasing H⁺ cations, which may react with the OH⁻ anions produced by, for example, reaction 306. This neutralization reaction may quench glass etching. Additionally, silicic acid may help precipitate lithium by reacting with lithium ions in the bath to form Li₂SiO₃. The silicic acid may be added to the molten salt bath either before the ion exchange process, or after a certain number of ion exchanges have occurred. However, if too much silicic acid is added to the bath, sludge may form on the bottom of the tank, which may be difficult to clean and may limit the life of the tank. Accordingly, there is a limited amount of silicic acid that may be added to the molten salt bath. In some embodiments, the concentration of the silicic acid added to the molten salt bath is within a range of 0.1 wt % to 2 wt % after it has been dissolved in the molten salt bath. For example, the concentration of the silicic acid added to the molten salt bath may be in a range of from greater than or equal to 0.1 wt % to less than or equal to 2 wt %, such as from greater than or equal to 0.2 wt % to less than or equal to 1.9 wt %, from greater than or equal to 0.3 wt % to less than or equal to 1.8 wt %, from greater than or equal to 0.4 wt % to less than or equal to 1.7 wt %, from 0.5 wt % to less than or equal to 1.6 wt %, from greater than or equal to 0.6 wt % to less than or equal to 1.5 wt %, from greater than or equal to 0.7 wt % to less than or equal to 1.4 wt %, from greater than or equal to 0.8 wt % to less than or equal to 1.3 wt %, from greater than or equal to 0.9 wt % to less than or equal to 1.2 wt %, or from greater than or equal to 1.0 wt % to less than or equal to 1.1 wt %, and all ranges and sub-ranges between the foregoing values.

Alternatively, in some embodiments, anhydrous sodium or potassium phosphate salts may be added into the molten salt bath in order to react with lithium and form lithium phosphate salts, for example, as shown in reaction 308. In some embodiments, a concentration of anhydrous sodium salt added to the molten salt bath is within a range of 0.05 wt % to 3 wt %. For example, the concentration of anhydrous sodium salt added to the molten salt bath may be from greater than or equal to 0.05 wt % to less than or equal to 3 wt %, such as from greater than or equal to 0.1 wt % to less than or equal to 2.5 wt %, from greater than or equal to 0.2 wt % to less than or equal to 2.4 wt %, from greater than or equal to 0.3 wt % to less than or equal to 2.3 wt %, from greater than or equal to 0.4 wt % to less than or equal to 2.2 wt %, from greater than or equal to 0.5 wt % to less than or equal to 2.1 wt %, from greater than or equal to 0.6 wt % to less than or equal to 2 wt %, from greater than or equal to 0.7 wt % to less than or equal to 1.9 wt %, from greater than or equal to 0.8 wt % to less than or equal to 1.8 wt %, from greater than or equal to 0.9 wt % to less than or equal to 1.7 wt %, from greater than or equal to 1 wt % to less than or equal to 1.6 wt %, from greater than or equal to 1.1 wt % to less than or equal to 1.5 wt %, or from greater than or equal to 1.2 wt % to less than or equal to 1.4 wt %, and all ranges and sub-ranges between the foregoing values.

Similarly, in some embodiments, a concentration of potassium phosphate salt added to the molten salt bath is within a range of 0.05 wt % to 3 wt %. For example, the concentration of potassium phosphate salt added to the molten salt bath may be from greater than or equal to 0.05 wt % to less than or equal to 3 wt %, such as from greater than or equal to 0.1 wt % to less than or equal to 2.5 wt %, from greater than or equal to 0.2 wt % to less than or equal to 2.4 wt %, from greater than or equal to 0.3 wt % to less than or equal to 2.3 wt %, from greater than or equal to 0.4 wt % to less than or equal to 2.2 wt %, from greater than or equal to 0.5 wt % to less than or equal to 2.1 wt %, from greater than or equal to 0.6 wt % to less than or equal to 2 wt %, from greater than or equal to 0.7 wt % to less than or equal to 1.9 wt %, from greater than or equal to 0.8 wt % to less than or equal to 1.8 wt %, from greater than or equal to 0.9 wt % to less than or equal to 1.7 wt %, from greater than or equal to 1 wt % to less than or equal to 1.6 wt %, from greater than or equal to 1.1 wt % to less than or equal to 1.5 wt %, or from greater than or equal to 1.2 wt % to less than or equal to 1.4 wt %, and all ranges and sub-ranges between the foregoing values.

Lithium phosphate salts, for example Li₃PO₄, Li₂NaPO₄, and Li₂KPO₄, have low solubility within the molten salt bath. Accordingly, the lithium can easily be precipitated and formation of Li₂CO₃ crystals may be avoided, as there is not enough Li⁺ present in the bath to react with CO₃²⁻. Like with silicic acid, alkali phosphate salts may be added to the molten salt bath either before the ion exchange process, or after a certain number of ion exchanges have occurred. Also similar to silicic acid, though, if too much alkali phosphate salt is added to the molten salt bath, sludge may form on the bottom of the tank.

In some embodiments, reducing the concentration of the Li₂CO₃ may be performed when the concentration of a non-carbonate lithium-containing salt (LiNO₃) within the molten salt bath reaches a concentration of 0.3 wt %.

Or, in some embodiments, the molten salt bath may be exposed to a CO₂ atmosphere during the ion exchange process. The addition of CO₂ may quench the production of haze in a number of ways without producing sludge. The reaction mechanism fundamentals are as follows:

a. Chemical reaction: CO₃²⁻+H₂O↔2OH⁻+CO₂ (for example, reaction 312);

$$b . Equilibrium constant \text{:} K = \frac{{[ OH ]}^{2} {P}_{{CO}_{2}}}{[ {CO}_{3} ] {P}_{{H}_{2} O}} ;$$

$$c . Equilibrium [ OH ] concentration \text{:} [ OH ] = \sqrt{\frac{K [ {CO}_{3} ] {P}_{{H}_{2} O}}{{P}_{{CO}_{2}}}} ; and$$

$$d . Equilibrium carbonate concentration \text{:} [ {CO}_{3} ] = \frac{{[ OH ]}^{2} {P}_{{CO}_{2}}}{{KP}_{{H}_{2} O}} .$$

As shown in equation (a), as moisture in the atmosphere within the furnace, and over the molten salt bath, enters the bath, it may react with carbonate salts to generate OH⁻ ions. The equilibrium OH⁻ concentration is determined by equation (c), which suggests that CO₂ may reduce the OH⁻ concentration in the salt bath by increasing the partial pressure of CO₂, and simultaneously decreasing the partial pressure of H₂O. In some embodiments, the partial pressure of CO₂ may be increased by more than 2500 times, for example from 0.3 mmHg to 760 mmHg, resulting in the reduction of OH⁻ by about 50 times, or up to 100 times, thereby quenching the glass etching process. Additionally, the CO₂ may replace the original air atmosphere within the furnace. Accordingly, the moisture in the original air atmosphere may be prevented from entering the salt bath, thereby further preventing formation of transmittance haze.

Furthermore, in some embodiments, the addition of CO₂ may aid in controlling the reversible reaction between Li₂CO₃ and the silicate glass (Li₂CO₃+SiO₂ (glass)↔Li₂SiO₃+CO₂), for example reaction 310. For example, when the partial pressure of the CO₂ in the atmosphere is increased to 760 mmHg, the reaction is likely to occur in the left direction (Li₂SiO₃+CO₂→Li₂CO₃+SiO₂ (glass)), thereby quenching corrosion of the glass by Li₂SiO₃.

Referencing FIG. 2, in some embodiments, the process for ion exchanging lithium containing glass substrates in a molten salt bath in the presence of a CO₂ atmosphere is as follows. A molten salt bath, for example molten salt bath 240, may be prepared within a tank, for example tank 220, according to any of the methods described herein, and may be disposed within a furnace, for example furnace 210. At least one lithium containing glass substrate, for example glass substrate 230, may be preheated at a temperature of, for example, 300° C. for about 15 minutes and then may be immersed in the molten salt bath. The lithium containing glass substrate may then be heated within the bath at a desired temperature, for example 380° C. for a time period necessary to allow for ion exchange to induce a target compressive stress on the surface of the substrate. In some embodiments, the necessary time period may be in the range of 60 minutes to 15 hours, including subranges. In some embodiments, the desired time period may be 60 minutes, 2 hours, 3 hours, 4 hours, 5 hours, 6 hours, 7 hours, 8 hours, 9 hours, 10 hours, 11 hours, 12 hours, 13 hours, 13.5 hours, 14 hours, or 15 hours. In some embodiments, the target compressive stress on the surface of glass substrate 230 is 200 MPa or more. In some embodiments, where multiple lithium containing glass substrates are ion exchanged, the target compressive stress on the surfaces of all of the glass substrates is 200 MPa or more.

CO₂ gas may be introduced into furnace 210 via gas outlet 250 to create a CO₂ atmosphere 252 within furnace 210. In some embodiments, gas outlet 250 may be placed in tank 240, and CO₂ gas may be bubbled directly into molten salt bath 240 for one hour or more. Gas outlet 250 may then be removed from tank 240, and placed beside it such that the CO₂ gas may completely fill an interior space 212 within furnace 210, thereby creating a CO₂ atmosphere 252 that remains in contact with molten salt bath 240. In some embodiments, the bubbling step may be omitted. In some embodiments, a concentration of CO₂ within the air inside the furnace is within a range of 10 wt % to 20 wt % in order to create a CO₂ atmosphere that is effective to increase a solubility limit of a lithium-containing carbonate salt within the molten salt bath. For example, the concentration of the CO₂ within the air inside the furnace may be greater than or equal to 10 wt % to less than or equal to 20 wt %, such as from greater than or equal to 11 wt % to less than or equal to 19 wt %, from greater than or equal to 12 wt % to less than or equal to 18 wt %, from greater than or equal to 13 wt % to less than or equal to 17 wt %, or from greater than or equal to 14 wt % to less than or equal to 16 wt %, and all ranges and sub-ranges between the foregoing values. In some embodiments, the CO₂ atmosphere may be effective to increase a solubility limit of a lithium-containing carbonate salt within the molten salt bath by 0.1 wt % or more.

In some embodiments, the CO₂ may be introduced into furnace 210 prior to beginning the ion exchange process by immersing glass substrate 230 in molten salt bath 240, or it may be introduced during the ion exchange process.

In some embodiments, a CO₂ atmosphere may be provided in conjunction with the introduction of silicic acid into the molten salt bath. In some embodiments, a CO₂ atmosphere may be provided in conjunction with the introduction of anhydrous phosphate salts into the molten salt bath.

In some embodiments, the CO₂ may be introduced into the furnace after the molten salt bath has been already been used to ion exchange multiple glass substrates. The introduction of carbonate salts may counteract lithium poisoning within the bath, and the CO₂ may further improve the longevity of the bath by preventing formation of Li₂CO₃ crystals. In some embodiments, under CO₂ atmosphere, a single molten salt bath may quench haze formation to at least 0.45 m²/kg salt, meaning that 0.45 square meters is the maximum glass substrate surface area that may be ion exchanged per 1 kg of salt before haze begins to form. In some embodiments, a single molten salt bath may be used to ion exchange a number of glass substrates, including from 2 to 5,000 glass substrates; from 5 to 5,000 glass substrates, from 10 to 5,000 substrates, from 10 to 2,000 substrates, from 10 to 1,000 substrates and from 10 to 500 substrates.

In some embodiments, the concentration of a non-carbonate lithium-containing salt within the molten salt bath may be monitored such that when a certain concentration is reached, the CO₂ gas may be introduced into the furnace to increase the solubility limit of Li₂CO₃. In some embodiments, when the concentration of the non-carbonate lithium-containing salt within the molten salt bath reaches a concentration of 0.3 wt %, the CO₂ gas may be introduced into the furnace to increase the solubility limit of Li₂CO₃. In some embodiments, the concentration of the non-carbonate lithium-containing salt may be monitored by collecting a sample of salt from the molten salt bath, dissolving the sample in water, and quantifying the concentration of inorganic cations, for example Li⁺, K⁺, or Na⁺, using ion chromatography. The concentration of Li⁺ cations may be used to calculate the concentration of LiNO₃.

Upon being removed from the molten salt bath, the glass article subjected to the ion exchange process under CO₂ atmosphere may have little to no transmittance haze on its surface, even when ion exchanged in a molten salt bath that had previously been used for ion exchange of glass substrates more than 50 times. In some embodiments, all glass articles that are subjected to the ion exchange process in the same molten salt bath may have little to no transmittance haze on their surfaces. In some embodiments, glass substrates that are ion exchanged under CO₂ atmosphere may have a transmittance haze of less than 0.05%, 0.04%, 0.03%, 0.02%, or 0.01%.

In some embodiments, up to 0.5 wt % of a concentration of the lithium-containing carbonate salt in the molten salt bath may be reduced as discussed herein. For example, the concentration of the lithium-containing carbonate salt in the molten salt bath may be reduced by greater than or equal to 0.1 wt % to less than or equal to 0.5 wt %, such as from greater than or equal to 0.15 wt % to less than or equal to 0.45 wt %, from greater than or equal to 0.2 wt % to less than or equal to 0.4 wt %, or from greater than or equal to 0.25 wt % to less than or equal to 0.35 wt %, and all ranges and sub-ranges between the foregoing values. These reductions may be achieved by dissolving silicic acid in the molten salt bath at a weight percentage as described herein and/or dissolving at least one of anhydrous sodium or a potassium phosphate salt in the molten salt bath at the weight percentages described herein.

The concentration of the lithium-containing carbonate salt within the molten salt bath may be measured using ion chromatography. A sample of the molten salt bath, weighing approximately 5 grams, is collected and placed into water to dissolve the salts completely. The volume of water used depends on the sensitivity of the ion chromatography instrument. For example, some ion chromatography instruments are capable of measuring ion concentrations when 5 grams sample of salts is dissolved in 250 mL of water. The ion chromatography instrument then measures the conductivities of different liquid zones within the sample, as each zone has differently charged ions. The conductivities of the zones are positively correlated with the concentrations of ions inside each zone. For example, when the concentration of ions is high, the conductivity is also high. Tests can be run for several minutes to several hours, depending on the diffusion speed of different ions within the sample, and are run at room temperature.

The results from the ion chromatography tests are then compared to a calibration sample. The calibration sample is prepared by testing a sample with a known ion concentration, and then determining the correlation constant between the measured conductivity and the known concentration. The measured conductivity is linearly related with the concentrations of ions, such that the results of a test sample with an unknown concentration can be plotted against the results of the calibration sample to determine ion concentration.

The concentration of non-carbonate lithium-containing salts may also be measured using the ion chromatography method described above.

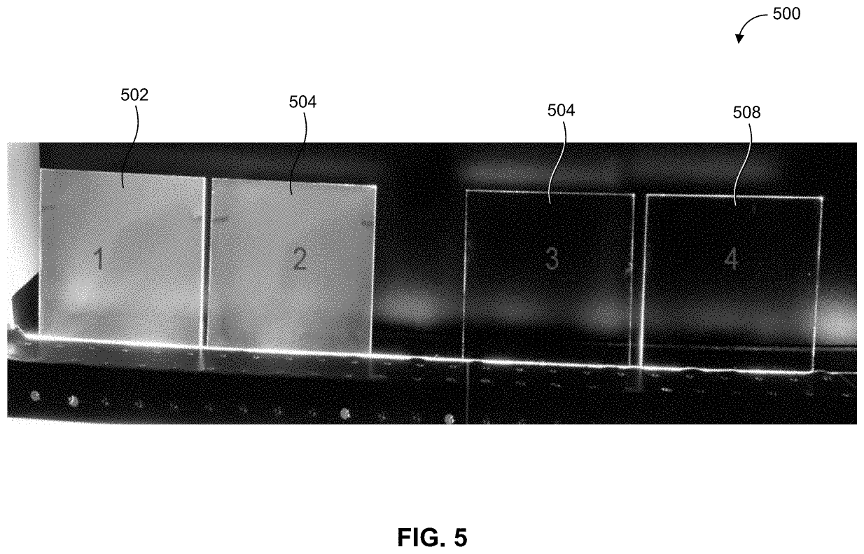

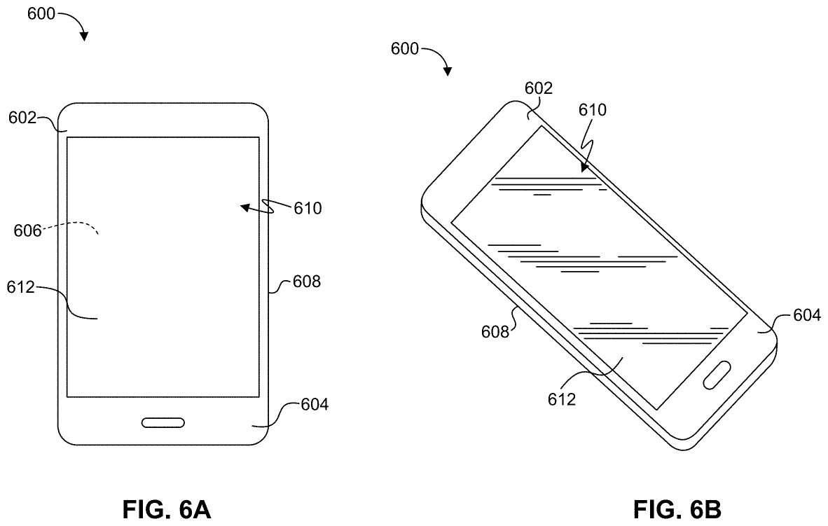

As shown in FIG. 5. image 500 includes four samples of glass articles—samples 502 and 504 were ion exchanged in a molten salt bath without any protection from CO₂ atmosphere within the furnace, while samples 506 and 508 were ion exchanged in a molten salt bath under CO₂ atmosphere. Samples 502 and 504 are visibly cloudy, due to transmittance haze, while samples 3 and 4 do not have any transmittance haze on their surfaces.

Because of their optical clarity and increased strength due to the induced surface compressive stresses, the glass articles disclosed herein may be incorporated into another article such as an article with a display (or display articles) (e.g., consumer electronics, including mobile phones, tablets, computers, navigation systems, and the like), architectural articles, transportation articles (e.g., automobiles, trains, aircraft, sea craft, etc.), appliance articles, or any article that requires some transparency, scratch-resistance, abrasion resistance or a combination thereof. An exemplary article incorporating any of the glass articles disclosed herein is shown in FIGS. 7A and 7B. Specifically, FIGS. 7A and 7B show a consumer electronic device 700 including a housing 702 having front 704, back 706, and side surfaces 708; electrical components (not shown) that are at least partially inside or entirely within the housing and including at least a controller, a memory, and a display 710 at or adjacent to the front surface of the housing; and a cover substrate 712 at or over the front surface of the housing such that it is over the display. In some embodiments, the cover substrate 712 and/or the housing 702 may include any of the glass articles disclosed herein.

While various embodiments have been described herein, they have been presented by way of example, and not limitation. It should be apparent that adaptations and modifications are intended to be within the meaning and range of equivalents of the disclosed embodiments, based on the teaching and guidance presented herein. It therefore will be apparent to one skilled in the art that various changes in form and detail can be made to the embodiments disclosed herein without departing from the spirit and scope of the present disclosure. The elements of the embodiments presented herein are not necessarily mutually exclusive, but may be interchanged to meet various situations as would be appreciated by one of skill in the art.

Embodiments of the present disclosure are described in detail herein with reference to embodiments thereof as illustrated in the accompanying drawings, in which like reference numerals are used to indicate identical or functionally similar elements. References to “one embodiment,” “an embodiment,” “some embodiments,” “in certain embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The examples are illustrative, but not limiting, of the present disclosure. Other suitable modifications and adaptations of the variety of conditions and parameters normally encountered in the field, and which would be apparent to those skilled in the art, are within the spirit and scope of the disclosure.

The indefinite articles “a” and “an” to describe an element or component means that one or at least one of these elements or components is present. Although these articles are conventionally employed to signify that the modified noun is a singular noun, as used herein the articles “a” and “an” also include the plural, unless otherwise stated in specific instances. Similarly, the definite article “the,” as used herein, also signifies that the modified noun may be singular or plural, again unless otherwise stated in specific instances.

As used in the claims, “comprising” is an open-ended transitional phrase. A list of elements following the transitional phrase “comprising” is a non-exclusive list, such that elements in addition to those specifically recited in the list may also be present. As used in the claims, “consisting essentially of” or “composed essentially of” limits the composition of a material to the specified materials and those that do not materially affect the basic and novel characteristic(s) of the material. As used in the claims, “consisting of” or “composed entirely of” limits the composition of a material to the specified materials and excludes any material not specified.

Where a range of numerical values is recited herein, comprising upper and lower values, unless otherwise stated in specific circumstances, the range is intended to include the endpoints thereof, and all integers and fractions within the range. It is not intended that the scope of the claims be limited to the specific values recited when defining a range. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed. Finally, when the term “about” is used in describing a value or an end-point of a range, the disclosure should be understood to include the specific value or end-point referred to. Whether or not a numerical value or end-point of a range recites “about,” the numerical value or end-point of a range is intended to include two embodiments: one modified by “about,” and one not modified by “about.”

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

The present embodiment(s) have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

It is to be understood that the phraseology or terminology used herein is for the purpose of description and not of limitation. The breadth and scope of the present disclosure should not be limited by any of the above-described exemplary embodiments, but should be defined in accordance with the following claims and their equivalents.

What is claimed is:

1. A chemical ion exchange process, comprising:
dissolving a carbonate salt in a molten salt bath disposed in a furnace and comprising a non-lithium non-carbonate alkali salt;
immersing a lithium-containing glass-based substrate in the molten salt bath comprising the dissolved carbonate salt and the non-lithium non-carbonate alkali salt, wherein immersing the lithium-containing glass-based substrate in the molten salt bath results in an ion-exchange between the lithium-containing glass-based substrate and the molten salt bath and results in the formation of a lithium-containing carbonate salt in the molten salt bath; and
reducing a concentration of the lithium-containing carbonate salt in the molten salt bath or increasing a solubility limit of the lithium-containing carbonate salt in the molten salt bath.

2. The process of claim 1, wherein reducing the concentration of the lithium-containing carbonate salt in the molten salt bath or increasing the solubility limit of the lithium-containing carbonate salt in the molten salt bath comprises one or more of:
(i) directing a gas comprising CO₂ into the furnace such that the molten salt bath is in contact with the gas;
(ii) dissolving silicic acid in the molten salt bath; or (iii) dissolving at least one of anhydrous sodium or a potassium phosphate salt in the molten salt bath.

3. The process of claim 2, wherein reducing the concentration of the lithium-containing carbonate salt in the molten salt bath comprises at least one of (ii) or (iii).

4. The process of claim 2, wherein increasing the solubility limit of the lithium-containing carbonate salt in the molten salt bath comprises (i).

5. The process of claim 2, wherein a concentration of the silicic acid within the molten salt bath is within a range of 0.1 wt % to 2 wt % after the silicic acid has been dissolved in the molten salt bath.

6. The process of claim 2, wherein the concentration of the lithium-containing carbonate salt in the molten salt bath is reduced by up to 0.5 wt %.

7. The process of claim 2, wherein the concentration of the lithium-containing carbonate salt in the molten salt bath is reduced by at least 0.1 wt %.

8. The process of claim 1, further comprising removing the lithium-containing glass-based substrate from the molten salt bath after a period of time sufficient to induce a target compressive stress on a surface of the lithium-containing glass-based substrate, wherein the lithium-containing glass-based substrate comprises a transmittance haze of less than 0.03% after being removed from the molten salt bath.

9. The process of claim 1, wherein a concentration of the lithium-containing carbonate salt in the molten salt bath is within a range of 0.1 wt % to 0.3 wt % before reducing the concentration of the lithium-containing carbonate salt or increasing a solubility limit of the lithium-containing carbonate salt.

10. The process of claim 1, wherein reducing the concentration of the lithium-containing carbonate salt in the molten salt bath or increasing a solubility limit of the lithium-containing carbonate salt in the molten salt bath is performed prior to immersing the lithium-containing glass-based substrate in the molten salt bath.

11. The process of claim 1, wherein reducing the concentration of the lithium-containing carbonate salt in the molten salt bath or increasing a solubility limit of the lithium-containing carbonate salt in the molten salt bath is performed while the lithium-containing glass-based substrate is immersed in the molten salt bath.

12. The process of claim 2, wherein the gas comprising CO₂ is configured to reduce an atmospheric moisture content of an interior space within the furnace to no more than 1%.

13. The process of claim 2, wherein directing the gas comprising CO₂ into the furnace comprises bubbling the gas inside the salt bath.

14. The process of claim 1, comprising monitoring a concentration of a non-carbonate lithium-containing salt in the molten salt bath, wherein reducing a concentration of the lithium-containing carbonate salt in the molten salt bath or increasing the solubility limit of the lithium-containing carbonate salt in the molten salt bath is performed when a concentration of the non-carbonate lithium-containing salt within the molten salt bath reaches at least 0.3 wt %.

15. A chemical ion exchange process, comprising:
dissolving a carbonate salt in a molten salt bath comprising a non-lithium non-carbonate alkali salt, the molten salt bath disposed in a furnace comprising a CO₂ atmosphere above the molten salt bath;
immersing a lithium-containing glass-based substrate in the molten salt bath comprising the dissolved carbonate salt and the non-lithium non-carbonate alkali salt, wherein immersing the lithium-containing glass-based substrate in the molten salt bath results in an ion-exchange between the lithium-containing glass-based substrate and the molten salt bath; and
removing the lithium-containing glass-based substrate from the molten salt bath after a period of time sufficient to induce a target compressive stress on a surface of the lithium-containing glass-based substrate, wherein the lithium-containing glass-based substrate comprises a transmittance haze of less than 0.03% after being removed from the molten salt bath.

16. The process of claim 15, further comprising bubbling a gas comprising CO₂ inside the salt bath.

17. The process of claim 15, further comprising immersing a second lithium-containing glass-based substrate in the molten salt bath comprising the dissolved carbonate salt and the non-lithium non-carbonate alkali salt after removing the lithium-containing glass-based substrate from the molten salt bath, wherein immersing the second lithium-containing glass-based substrate in the molten salt bath results in an ion-exchange between the second lithium-containing glass-based substrate and the molten salt bath, and
removing the second lithium-containing glass-based substrate from the molten salt bath after a period of time sufficient to induce a target compressive stress on a surface of the second lithium-containing glass-based substrate,
wherein the second lithium-containing glass-based substrate comprises a transmittance haze of less than 0.03% after being removed from the molten salt bath.

18. A chemical ion exchange process, comprising:
dissolving a carbonate salt in a molten salt bath disposed in a furnace and comprising a non-lithium non-carbonate alkali salt;
immersing a first lithium-containing glass-based substrate in the molten salt bath for a period of time sufficient to induce a target compressive stress on a surface of the first lithium-containing glass-based substrate;
immersing a second lithium-containing glass-based substrate in the molten salt bath for a period of time sufficient to induce a target compressive stress on a surface of the second lithium-containing glass-based substrate; and
directing a gas comprising CO₂ into the furnace such that the molten salt bath is in contact with the gas before immersing at least one of: the first lithium-containing glass-based substrate in the molten salt bath or the second lithium-containing glass-based substrate in the molten salt bath.

19. The process of claim 18, wherein the first lithium-containing glass-based substrate comprises a transmittance haze of less than 0.03% after being removed from the molten salt bath, and
wherein the second lithium-containing glass-based substrate comprises a transmittance haze of less than 0.03% after being removed from the molten salt bath.

20. A first lithium-containing glass-based article and a second lithium-containing glass-based article produced by the process of claim 18.
